(19) United States
(12) Patent Application Publication
(10) Pub. No.: US 2006/0213739 A1
(43) Pub. Date: Sep. 28, 2006

(54) Magnetic drive transmission device having heat dissipation, magnetic permeability and self-lubrication functions

(76) Inventor: Sun Shin-Ching, Taipei (TW)

Correspondence Address: SUN SHIN-CHING, P. O. BOX 24-108, TAIPEI, TW

(21) Appl. No.: 11/089,406

(22) Filed: Mar. 25, 2005

(51) Int. Cl. F16D 35/00

(52) U.S. Cl. 192/21.5; 188/267.1

(57) ABSTRACT

The present invention discloses a magnetic drive transmission device having heat dissipation, magnetic permeability and self-lubrication functions, and suspending a nano magnetic permeable matter such as the nano Fe2O3, Fe3O4, nickel, cadmium and copper in oil by denaturing the aliphatic functional group to produce a superparamagnetic and magnetic permeable oily matter. Such oily matter substitutes magnetic cores and lubricant oil to fill the housing of a driving transmission assembly such as a magnet, a coil, an accelerator, a clutch and a pump, etc, and works with a magnetic control device to produce the heat dissipating and self-lubricating effects inside the housing of the magnetic drive transmission assembly since the general nanocomposite particles are very small that will not affect the mobility and slidability of the oil. If the drive comes with a magnetic force, then the magnetic permeability of the nanocomposite material can be collected instantly according to the magnitude of the magnetic force, which changes the viscosity of the oil or even forms a rigid body to achieve the low-noise, low power consumption and instant changing or locking drive transmission. Since the magnetic drive transmission mechanism is totally filled with oily fluid that gives a better magnetic permeable circuit and insulation protection, therefore the present invention provides a broader application and improves the function of the magnetic drive transmission function.

### BACKGROUND OF THE INVENTION

1. Field of the Invention

The present invention relates to a magnetic drive transmission device having heat dissipation, magnetic permeability and self-lubrication functions, more particularly to a magnetic drive transmission device that overcomes the shortcomings of having a poor performance and an easy damage and improves the issues of producing frictions and noises, consuming much power, and having poor superparamagnetism and insulation.

The present invention suspends a nano magnetic permeable matter such as the nano Fe₂O₃, Fe₃O₄, nickel, cadmium and copper in an oil by denaturing an aliphatic functional group to produce a superparamagnetic and magnetic permeable oily matter. Such oily matter substitutes a magnetic core and lubricant oil and fills up the housing of a driving transmission assembly such as a magnet, a coil, an accelerator, a clutch and a pump, etc, and works together with a magnetic control device to produce the effects for heat dissipation and self-lubrication inside the housing of the magnetic drive transmission assembly since the general nanocomposite particles are very small that will not affect the mobility and slidability of the oil. If the drive assembly comes with a magnetic force, then the magnetic permeability of the nanocomposite material can be collected instantly according to the magnitude of the magnetic force, which will change the viscosity of the oil or even form a rigid body to achieve the low-noise, low power consumption and instant changing or locking drive transmission. Since the magnetic drive transmission mechanism is filled up with an oily fluid that gives a better magnetic permeable circuit and insulation protection, therefore the present invention provides a broader application and improves the function of the magnetic drive transmission.

2. Description of the Related Art

In general, most of the present magnetic driving components use a silicon steel plate to make a magnetic core for the effects of paramagnetism and magnetic permeability. However, a gap and some air exist between the silicon steel plate and the coil, so that the improvements on paramagnetism, magnetic permeability, heat dissipation and insulation effect are restricted, and its assembling is laborious and time-consuming. To prevent the transmission body from being worn out and damaged, a lubricant oil is filled, but the lubricant oil will reduce the engagement and the transmission performance. Therefore, it is necessary to study and improve the performance of the magnetic drive transmission body.

### SUMMARY OF THE INVENTION

In view of the foregoing shortcomings of the prior art, the inventor of the present invention based on years of experience on engaging in the business of the magnetic drive transmission device conducted extensive researches and experiments, and finally invented the magnetic drive transmission device having heat dissipation, magnetic permeability and self-lubricating functions in accordance with the present invention.

The primary objective of the present invention is to provide a magnetic drive transmission device having heat dissipation, magnetic permeability and self-lubrication functions, which suspends a nano magnetic permeable matter such as the nano Fe₂O₃, Fe₃O₄, nickel, cadmium and copper in an oil by denaturing an aliphatic functional group to produce a superparamagnetic and magnetic permeable oily matter. Such oily matter substitutes a magnetic core and a lubricant oil to fill up the housing of a driving transmission assembly such as a magnet, a coil, an accelerator, a clutch and a pump, etc, and works together with a magnetic control device to produce the heat dissipating and self-lubricating effects inside the housing of the magnetic drive transmission assembly, since the general nanocomposite particles are very small that will not affect the mobility and slidability of the oil. If the drive assembly comes with a magnetic force, then the magnetic permeability of the nanocomposite material can be collected instantly according to the magnitude of the magnetic force, which changes the viscosity of the oil or even forms a rigid body to achieve the low-noise, low power consumption and instant change or locking the drive transmission, and improve the functions of the magnetic drive transmission assembly.

The secondary objective of the present invention is to provide a magnetic drive transmission device having heat dissipation, magnetic permeability and self-lubrication functions. Since the magnetic drive transmission mechanism is filled up with an oily fluid that gives a better magnetic permeable circuit and insulation protection, therefore the present invention provides a broader application and improves the function of the magnetic drive transmission function.

### BRIEF DESCRIPTION OF THE DRAWINGS

FIG. 1 is a side cross-sectional view of the driving device according to a preferred embodiment of the present invention.

FIG. 2 is a side cross-sectional view of the transmission device according to a preferred embodiment of the present invention.

FIG. 3 is a side cross-sectional view of the damper device according to a preferred embodiment of the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

Please refer to the figures for the present invention. The magnetic drive transmission device having heat dissipation, magnetic permeability and self-lubrication functions according to the present invention comprises a nano magnetic permeable oil 1, a drive transmission assembly 2 and a housing 3; wherein the nano magnetic permeable oil 1 is a nano magnetic material such as the nano Fe₂O₃, Fe₃O₄, nickel, cadmium and copper in an oil that denatures an aliphatic functional group to produce a superparamagnetic and magnetic permeable oily matter; the drive transmission device 2 comprises a magnet and a coil for producing magnetism or is disposed in a transmission shaft that constitutes a transmission device such as an accelerator, a clutch or a pump that is engaged with a damper mechanism, and the nano magnetic oil substitutes the magnetic core or lubricant oil to fill up the housing 3 of a transmission assembly 2 such as a magnet, a coil, an accelerator or a clutch, and the transmission device works together with a magnetic control device 4 disposed outside the housing 3.

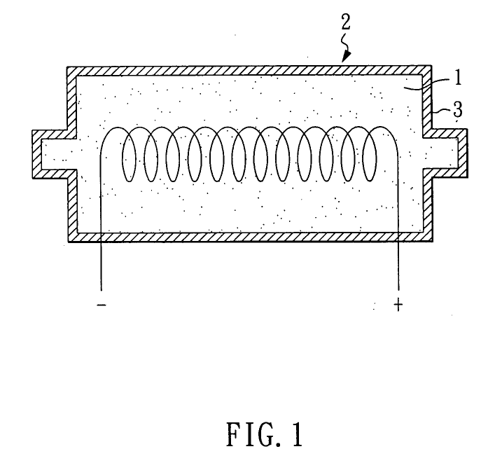

In the practical applications of the present invention being used in a driving device such as a relay, a motor and the like (as shown in FIG. 1), a nano magnetic oil 1 substitutes the magnetic core and is dipped between a magnet (silicon steel plate) and a coil to fill the whole space and discharge the air. Such arrangement of using a liquid for the magnetic permeability gives a better magnetic permeable circuit, and the substrate is made of a superparamagnetic material and can be applied in a broader operating frequency and thus in turn enhances the magnetic flux of the electronic product, the overload bearing capability, heat dissipation and insulation effects.

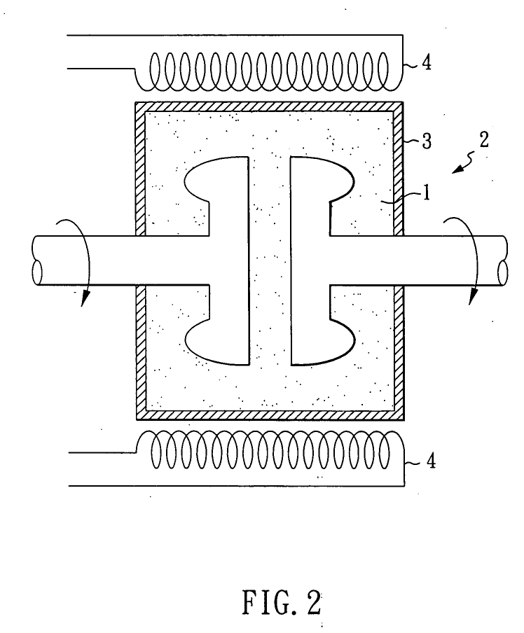

If the present invention is applied in transmission devices such as an accelerator, a clutch and the like (as shown in FIG. 2), the nano magnetic permeable oil 1 substitutes the lubricant oil, and a movable magnet or an electronic magnetic control device 4 disposed at an appropriate position outside the housing 3 of the drive transmission assembly 2. When the magnetic control device 4 produces a magnetic field, the magnetic permeable material in the nano magnetic permeable oil 1 inside the housing 3 senses the magnetic field to produce an aggregation and changes the mobility of the magnetic permeable material. In other words, the speed of the flow of the nano magnetic permeable oil 1 changes and increases the resistance and decreases the slip difference between the motive force input wing and the output wing, so that the motive force can be outputted successfully from the output wing, and the magnitude of the motive force is determined by the rotary speed and continual time of the magnetic field. Unlike the prior-art which solely depends on the rotary speed, the ratio of the rotation and the rotary speed difference of the motive force is synchronous with the pulse of the electric power if the magnetic field is controlled by the interval pulse power. That is, the ratio of the transmissions of motive force is changed from 1:1 to 1:∞, and the magnitude of the torque is equal to the magnitude of the magnetic field, which controls the slip difference of the mobility of the magnetic permeability of the nano magnetic permeable oil 1, because the nano magnetic material 1 between the input and output wings changes the viscosity and mobility to automatically change the torque. Therefore, if the torque and speed change ratio is inputted by the automatic programmable chip and the circuit control to accomplish a gearless electronic transmission device and adjust the torque anytime to achieve the advantages of a low wearing gearless, a transmission, a free torque control, a simple equipment and a fast reaction. The present invention greatly improves the design for a light, thin, short, compact and high-performance requirement for the current industry and automatic motor vehicles.

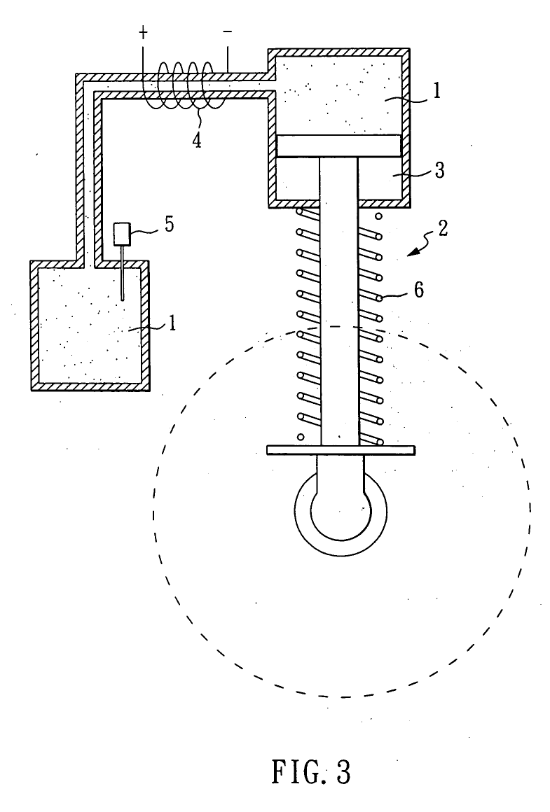

Further, the invention also can be used as a shockproof damper device as shown in FIG. 3, which uses a nano magnetic permeable oil 1 to substitute the oil fluid in the shockproof damper device, and a magnetic control device 4 is disposed on a side of an oil pipe, and a pressure sensor 5 is disposed on the shockproof damper device for detecting the pressure and sending the data of the pressure to the control chip for recording and calculation, and further controls the magnetic control device 4 to produce a magnetic field, so that the viscosity of the magnetic permeable material of the nano magnetic permeable oil 1 changes and affects its mobility, and thus results in a change of the speed and the quantity of oil entering or exiting the primary and secondary oil barrels of the shockproof damper device, and also a change to the pressure curve of the softness, hardness, and reaction distance of the shockproof damper device in order to achieve the automatic stable effects of producing an absorption of a quick slight bouncing force or a large dynamic shock by means of the spring 6.

A nanocomposite powder such as a nano talc powder or an inorganic mica heat-resisting nano lubricating material can be used as needed to substitute the traditional additives such as the molybdenum disulfide that does not resist high-temperature heat and will change its properties easily. Such arrangement can improve the high-temperature operability of the nano magnetic permeable oil 1 and attain the high-temperature lubricating feature.

In summation of the description above, the present invention overcomes the shortcomings of the prior-art and enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements.

What is claimed is:

1. A magnetic drive transmission device having heat dissipation, magnetic permeability and self-lubricating functions, comprising a nano magnetic permeable oil, a drive transmission assembly and a housing; wherein said drive transmission assembly using a magnet and a coil for an electric connection to produce a magnetic drive device, and said nano magnetic permeable oil being a nano magnetic permeable material selected from a collection of Fe₂O₃, Fe₃O₄, nickel, cadmium, and copper for denaturing said nano magnetic permeable material by an aliphatic functional group, and said nano magnetic permeable material being mixed and suspended in an oil, and thus becoming an oil matter having paramagnetism and magnetic permeability, and said magnetic permeable oil substituting a magnetic core and filling up a housing of said drive transmission assembly containing a magnet and a coil.

2. The magnetic drive transmission device having heat dissipation, magnetic permeability and self-lubricating functions of claim 1, wherein said drive transmission assembly is a transmission device selected from a collection of an accelerator, a clutch and a pump and disposed in a transmission shaft that constitutes and engages a damper device, and said nano magnetic permeable oil substitutes a lubricant oil to fill up the housing of said drive transmission assembly containing said accelerator and clutch and a magnetic control device is installed outside said housing for producing a sensing effect on said nano magnetic permeable oil.

3. The magnetic drive transmission device having heat dissipation, magnetic permeability and self-lubricating functions of claim 2, wherein said nano magnetic permeable oil is one selected from the collection of a nano talc powder, an inorganic mica nano lubricating material to substitute a molybdenum disulfide additive.
